(19) United States
(12) Patent Application Publication
(10) Pub. No.: US 2022/0153640 A1
(43) Pub. Date: May 19, 2022

(54) Particle Size Distribution of Low Carbon Ordinary Portland Cement

(71) Applicant: Furno Materials Inc., Palo Alto, CA (US)

(72) Inventor: Gurinder Nagra, Palo Alto, CA (US)

(73) Assignee: Furno Materials Inc., Palo Alto, CA (US)

(21) Appl. No.: 17/497,929

(22) Filed: Oct. 9, 2021

Related U.S. Application Data
(63) Continuation-in-part of application No. 17/384,672, filed on Jul. 23, 2021.
(60) Provisional application No. 63/089,620, filed on Oct. 9, 2020.
(60) Provisional application No. 63/212,529, filed on Jun. 18, 2021.
(60) Provisional application No. 63/212,535, filed on Jun. 18, 2021.
(60) Provisional application No. 63/108,418, filed on Nov. 1, 2020.
(60) Provisional application No. 63/055,826, filed on Jul. 23, 2020.

(51) Int. Cl. C04B 7/02; C04B 7/44

(52) U.S. Cl. CPC C04B 7/02; C04B 7/44

(57) ABSTRACT

There is provided high temperature furnaces, calcining, pyrolysis and other high temperature manufacturing processes, composition rearrangements, and equipment. Generally, embodiments the present inventions relate to systems, equipment and processes using oxyfuel for high temperature processing of materials for the production of cements having a particle size distribution from about 0.1 μm to about 150 μm.

This application: (i) claims priority to, and under 35 U.S.C. § 119(e)(1) the benefit of the filing date of U.S. provisional application Ser. No. 63/089,620 filed Oct. 9, 2020; and (ii) is a continuation in part of U.S. application Ser. No. 17/384,672 filed Jul. 23, 2021, the entire disclosure of each of which is incorporated herein by reference.

### BACKGROUND OF THE INVENTION

### Field of the Invention

The present invention relates to the manufacture of materials including cement having predetermined particle sizes, and particle size distribution.

As used herein, unless stated otherwise, the term “cement” is to be given its broadest possible meaning and would include, materials that are made from lime, iron, silica and alumina at temperatures in the general range of about 2,500° F. (1,371° C.) to 2,800° F. (1,537.8° C.), materials that are made from calcium, silicon, aluminum, iron and gypsum at temperatures in the general range of about 2,500° F. (1,371° C.) to 2,800° F. (1,537.8° C.) roman cements, Portland cements, hydraulic cements, blended hydraulic cements, materials that meet, portland-limestone cement, portland-slag cement, portland-pozzolan cement, ternary blended cements, sulfate resistant cements, or have components that meet, one or more of the following American Society for Testing and Materials (“ASTM”) standards, (which standards are incorporated herein by reference) ASTM C150, ASTM C595, C1157, ASTM 109. The term cement includes the dry, wet and hardened states or forms of these materials.

As used herein, unless stated otherwise, the term “concrete” is to be given its broadest possible meaning and would include, materials that have an aggregate and a binder, which is typically cement. Water is added to this mixture and a chemical reaction takes place over time to provide a solid material or structure. The term concrete includes the dry, wet and hardened states of these materials.

As used herein, unless stated otherwise, the term “pourable” is to be given its broadest possible meaning and would include liquids, powders, molten materials, flowable pastes, and gases. As used herein with respect to cement or concrete, the term references to both the powdered mixture (e.g., dry mix) and the liquid mixture when water is added (e.g., ready-mix) before the cement or concrete sets-up into a semi-solid and then solid material.

Typically, cement is mainly produced by means of sintering a mixed powder of limestone and silica at 1350 to 1450 C in a rotary furnaces/kiln via air-fuel combustion to form clinker—nodules which are grinded and mixed with additives like gypsum to form the final composition of cement. The prevalence of inert Nitrogen in the flue gas of traditional cement production facilities using air-fuel combustion makes carbon capture (>90% pure stream of CO₂) an expensive option as flue gases from cement contain <about 20% concentration of CO₂. Furthermore, a significant portion of the heat released from combustion in air heats up the inert nitrogen in the air and is wasted as these gases exit the flue gas stack—reducing the overall energy efficiency of the process.

In general, prior cement kilns utilize a design in which flame temperature does not exceed about 1900° C. to maintain the structural integrity of the refractory lining of the kiln. Exceeding this temperature limit can both weaken the support structure of the furnace and cause rapid chemical reactions to wear the refractory lining of existing kilns. As a result, combustion systems with temperatures in excess of 1900° C. are avoided by the traditional cement industry and instead systems are designed to not exceed the upper limit of 1900° C.

The term “clinker”, “cement clinker”, “Portland cement clinker”, and other similar terms, as used herein, unless specified otherwise, are to be given there broadest possible meaning and would include, the solid material that initially exits or is produced from a kiln or furnace in the manufacture of cement, where the material is as an intermediary product. Generally, canker occurs as lumps or nodules, usually in the range of about 3 millimeters (mm) (0.12 in) to about 25 mm (0.98 in) in diameter, as well as, larger and smaller sizes, and sizes within this range.

In the manufacture of cement, including Portland cement, this initial material, i.e., clinker, then undergoes comminution, e.g., grinding, into finer powders. These powders can have a particle size distribution ranging, from submicron to about 100 microns (μm). Portland cement particle size distribution can extend over a wide and substantially continuous band of particle sizes.

Prior to the present inventions, however, the advantages of the oxyfuel combustion system have never been realized in the cement industry. The designs of prior furnaces, kilns and cement production lines is such that the prior furnaces, kilns and processes, have been incapable of utilizing the benefits of oxyfuel combustion. The refractory materials and design ultimately dictate the upper temperature thresholds to which industrial systems such as cement production can handle. As a result, air-fuel combustion systems which have lower adiabatic flame temperatures ˜ or <1900° C. are used in the cement industry furnaces, as these temperatures are within material limitations, they do not hinder the operation of a furnace.

Generally, the term “about” and the symbol “˜” as used herein, unless specified otherwise, is meant to encompass a variance or range of ±10%, the experimental or instrument error associated with obtaining the stated value, and preferably the larger of these.

As used herein, unless expressly stated otherwise terms such as “at least”, “greater than”, also mean “not less than”, i.e., such terms exclude lower values unless expressly stated otherwise.

As used herein, unless stated otherwise, room temperature is 25° C. And, standard temperature and pressure is 25° C. and 1 atmosphere. Unless expressly stated otherwise all tests, test results, physical properties, and values that are temperature dependent, pressure dependent, or both, are provided at standard temperature and pressure.

As used herein, unless specified otherwise, the recitation of ranges of values, a range, from about “x” to about “y”, and similar such terms and quantifications, serve as merely shorthand methods of referring individually to separate values within the range. Thus, they include each item, feature, value, amount or quantity falling within that range. As used herein, unless specified otherwise, each and all individual points within a range are incorporated into this specification, and are a part of this specification, as if they were individually recited herein.

The term “multi-modal”, as used herein, unless specified otherwise, means a pattern of size distribution in which there are two or more distinct bands or modes of particle sizes present, the intermediate particle sizes between adjacent main bands or modes being present only in a substantially reduced proportion, so that the overall size distribution is no longer substantially continuous.

The term “low carbon cement” as used herein, unless specified otherwise, means any cement that is produced by a process in which the amount of carbon released to the atmosphere is less than 1% of the weight of the cement clinker produced.

The term “carbon neutral cement” as used herein, unless specified otherwise, means any cement that is produced by a process in which the amount of carbon released to the atmosphere is less than 0.01% of the weight of the cement clinker produced.

This Background of the Invention section is intended to introduce various aspects of the art, which may be associated with embodiments of the present inventions. Thus, the foregoing discussion in this section provides a framework for better understanding the present inventions, and is not to be viewed as an admission of prior art.

### SUMMARY

There is a continuing and increasing need to for new and more efficient and environmentally sound, systems, equipment and methods for performing high temperature processing of materials, including cements, concretes, road surface materials, flooring materials, countertop materials and other pourable structural and design materials.

The present invention, among other things, solves these needs by providing the materials, compositions, and methods taught herein.

Thus, there is provided a method of making a cement having a multi-modal particle size distribution, having particles having a diameter, from 0.1 ¬μm to about 150 ¬μm, and producing low carbon emissions, whereby at least 98% of any carbon used in the method is captured.

Furthermore, there are provided these methods, cements and materials having one or more of the following features: wherein at least 99.5% of the carbon that is used to make the cement is captured, and thus not released to the atmosphere; wherein the cement is a Portland cement; wherein the cement comprises a bi-modal distribution, wherein the distribution has at least two bands; having a first band having a first band peak, and a second band having a second band peak; wherein a difference between the first band peak and the second band peak is at least 50 ¬μm; wherein a difference between the first band peak and the second band peak is at least 75 ¬μm; wherein the ratio of the first band peak to the second band peak is at least 2; wherein the ratio of the first band peak to the second band peak is at least 5; wherein the ratio of the first band peak to the second band peak is from 2 to about 10; wherein the second band is a course band; wherein the first band is a fine band; wherein the cement particle size distribution comprises a third band; wherein the third band is an intermediate band; wherein the second band is an intermediate band; wherein at least one of the bands has a narrow particle size distribution; wherein at least two of the bands have a narrow particle size distribution; wherein at least one of the bands defines a D10 value and a D90 value and the difference between the D10 and D90 values is less than 20 ¬μm; and, wherein at least one of the bands defines a D10 value and a D90 value; and the difference between the D10 and D90 values is less than 10 ¬μm.

Still additionally, there is provided a low carbon cement having a particle size distribution having a first band and a second band, wherein the first band comprises a first band peak, and the second band comprises a second band peak, wherein the ratio of the first band peak to the second band peak is from about 2 to about 10.

Furthermore, there are provided these methods, cements and materials having one or more of the following features: wherein the particle size distribution consists essentially of a bi-modal distribution; thereby defining a bi-modal distribution; and, wherein the particle size distribution comprises a third band.

Moreover, there is provided a carbon neutral cement having a particle size distribution having a first band and a second band, wherein the first band comprises a first band peak, and the second band comprises a second band peak, wherein the ratio of the first band peak to the second band peak is from about 2 to about 10.

Furthermore, there are provided these methods, cements and materials having one or more of the following features: wherein the particle size distribution consists essentially of a bi-modal distribution; thereby defining a bi-modal distribution; and, wherein the particle size distribution comprises a third band.

Yet additionally, there is provided a plurality of starting material pellets configured for use in the manufacture of a cement: the pellets having silica and calcium carbonate; the pellets having particle sizes within the range of 20 mm to 80 mm; the pellets having at least one distribution band having a D10 value and a D90 value, and thereby defining a first band width.

Furthermore, there are provided these methods, cements and materials having one or more of the following features: having a second distribution band having a D10 value and a D90 value, and thereby defining a second band width; wherein the first band width, the second band width or both is less than 20 mm; wherein the first band width, the second band width or both is less than 10 mm; wherein the first band width, the second band width or both is less than 5 mm; wherein a difference between a peak of the first band and a peak of the second band is at least 50 mm; wherein a difference between a peak of the first band and a peak of the second band is at least 100 mm; wherein a difference between a peak of the first band and a peak of the second band is less than 75 mm; wherein a difference between a peak of the first band and a peak of the second band is less than 50 mm; having a third distribution band; and, wherein the starting material consists essential of a tri-modal distribution.

Furthermore, there is provided a method for producing cement having a particle size distribution from about 0.1 ¬μm to about 150 ¬μm, the method including the steps of: feeding a starting material pellets having limestone and a source of silica into a furnace; feeding oxygen at high purity into the furnace; feeding a fuel having, carbon, hydrogen, or both into the furnace; combustion oxygen with the fuel in the furnace, where the combustion reaction provides high flame temperatures above 2000 C; thereby producing a cement clinker.

Furthermore, there are provided these methods, cements and materials having one or more of the following features: processing the cement clinker into a cement; wherein the cement is a Portland cement; wherein staring material pellets have a particle size of from about 10 mm to about 110 mm; wherein staring material pellets have a uni-modal particle size distribution, a bi-modal particle size distribution, or a tri-modal particle size distribution; wherein the cement clinker defines a particle size distribution that is bi-modal; wherein the cement defines a particle size distribution that is bi-modal; wherein the cement clinker defines a particle size distribution that is tri-modal; wherein the cement defines a particle size distribution that is tri-modal; wherein the cement clinker defines a particle size distribution that is multi-modal; wherein the cement defines a particle size distribution that is multi-modal; wherein the starting material pellets has an available surface area of from about 300 to about 66.6 m2/m3; wherein the starting material pellets has an available surface area of greater than 60 m2/m3; wherein the starting material pellets has an available surface area of greater than about 70 m2/m3; wherein the starting material pellets has an available surface area of from about 300 to about 66.6 m2/m3; wherein the starting material pellets has an available surface area of greater than 60 m2/m3; and, wherein the starting material pellets has an available surface area of greater than about 70 m2/m3.

Thus, there is provided a cement and a method of manufacturing the cement using oxyfuel combustion system in a vertical shaft kiln. This process first involves the pellet formation of the raw materials which go into an oxyfuel combustion furnace. The size of the pellets can range from about 20 mm to about 90 mm in size. This produces clinker nodules which are the intermediary product and this is ground to a particle size distribution ranging from about 1 μm to about 100 μm in size.

Further there is provided an oxyfuel natural gas system used with dry granulation pellet formation to produce a pure stream of CO₂ which can be compressed and sold or stored geologically and clinker which is of similar or the same composition as clinker coming out of a traditional kiln. This is clinker is ground and mixed with additives like gypsum to produce the same composition and same of different particle size distribution of Portland cement, and in particular the particle size and distribution of commercially acceptable Portland cements, as well as, other commercially acceptable cements, and also include particle size and distribution coming within one or more of the following standards ASTM C150, ASTM C595, C1157, and ASTM 109.

There is further provided methods of making cements, including Portland cements, the use of raw material in pellet form of any uniform pellet size between about 20 mm and 90 mm or a multimodal distribution of pellet size between 20 mm and 90 mm. to provide a single continuous band of cement with particle sizes from the 0.1 μm to 150 μm scale where the average particle size lies anywhere between the two parameters. There is also provided a multi-modal distribution of particle sizes in the cement that are known to improve the flexural strength characteristics of cement.

### BRIEF DESCRIPTION OF THE DRAWINGS

FIG. 1A is a graph showing an embodiment of a uni-modal particle size distribution in accordance with the present inventions.

FIG. 1B is a graph showing an embodiment of a uni-modal particle size distribution in accordance with the present inventions.

FIG. 2 is a graph showing an embodiment of a bi-modal particle size distribution in accordance with the present inventions.

FIG. 3 is a graph showing an embodiment of a tri-modal particle size distribution in accordance with the present inventions.

FIG. 4 is a graphs showing particle size distributions having D10, D50 and D90 in accordance with the present inventions.

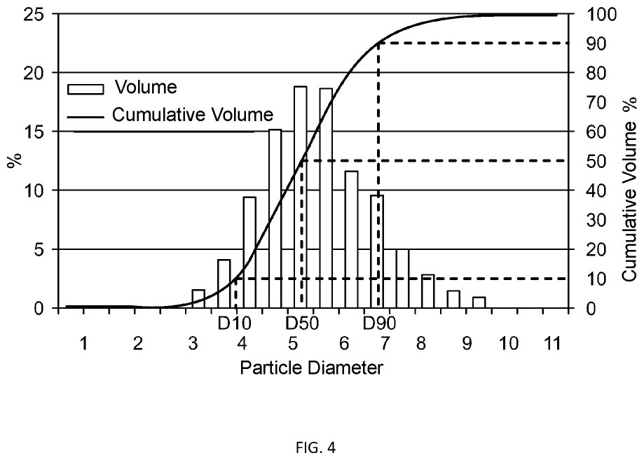

### DESCRIPTION OF THE PREFERRED EMBODIMENTS

The present inventions relate to high temperature furnaces, calcining, pyrolysis and other high temperature manufacturing processes, composition rearrangements, and equipment.

Generally, embodiments the present inventions relate to systems, equipment and processes using oxyfuel for high temperature processing of materials.

Generally, in embodiments of the present inventions there are provided configurations, systems and process using a furnace, e.g., a kiln. These embodiments utilize oxyfuel combustion to provide furnaces, e.g., kilns, that are more efficient, produce a pure stream of CO₂, have smaller footprints (e.g., smaller size for the same or more output), lower costs, and combinations and variations of these, as well as, other advantages compared to prior furnaces and kilns, and oxyfuel processes.

The systems, equipment and methods using a temperature driven oxyfuel combustion technology, such as that described in provisional application Ser. No. 63/055,826 filed Jul. 23, 2020 (which is a part of priority application U.S. Ser. No. 63/089,620) and U.S. patent application Ser. No. 17/384,672 filed Jul. 23, 2021, the entire disclosure of each of which is incorporated herein by reference, can improve the energy efficiency of cement kiln production while producing a pure stream of CO², reducing size and improving productivity (for example, as measured by >3 t/m³). These are benefits, among others, that the oxyfuel combustion technology provides over prior kilns and methods of cement manufacture.

Generally, embodiments of the present systems and methods may use oxyfuel combustion for the purpose of manufacturing cement or air fuel combustion with natural gas in a kiln embodiment described in provisional application Ser. No. 63/055,826 filed Jul. 23, 2020 (which is a part of the priority application U.S. Ser. No. 63/089,620) and U.S. patent application Ser. No. 17/384,672 filed Jul. 23, 2021, the entire disclosure of each of which is incorporated herein by reference.

Generally, embodiments of the present systems and methods can be a furnace, e.g., a kiln, that has linings and refractory materials that withstand and operate flame temperatures greater than 1,900° C., greater than 2,000° C., greater than 2,500° C., greater than 2,800° C., from about 2,000° C. to about 2,800° C., about 2,500° C., about 2,600° C., about 2,700° C., and about 2,800° C., as well as greater and lower temperatures, that are provided by methods utilizing the oxyfuel combustion process. Thus, these embodiments of the present systems operate at temperature at least 500 C, 700 C, 900 C greater than conventional air-fuel combustion systems which have much lower adiabatic flame temperatures ˜ or <1900° C. These systems can operate with other fuel systems or combustion systems in addition to using just an oxyfuel system. Ultimately, in a preferred embodiment, both air-fueled and oxyfuel furnaces produce cement clinker of a similar composition that falls within the ASTM C150 Standards.

Generally, in embodiments of the present systems and methods the production of pellets (e.g., particles, powders) from raw material is done before heating and processing the material in a furnace, e.g., a kiln, and process as described in this specification. The pellets are preferably formed with minimum use of moisture using the dry granulation method or briquetting of raw material between 20 mm and 90 mm in size. Pellets in this size range can also be produced using other pellet formation processes for example using starch-based binders or moisture in a disc-pelletizer to coagulate granules to make pellets. In making cement, these pellets are put into the kiln (thus would be a starting material) and are heated and processed in the kiln and come out of the kiln as cement clinker, which is an intermediary product. The cement clinker is then grinded in a cement mill and combines with additives such as gypsum, etc. to the preferred final particle size distribution of cement. This is preferably bi-modal, but may be tri-modal. The number of modes may be even greater, for example four.

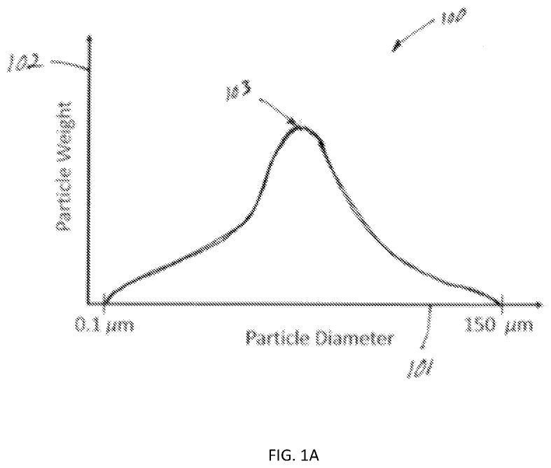

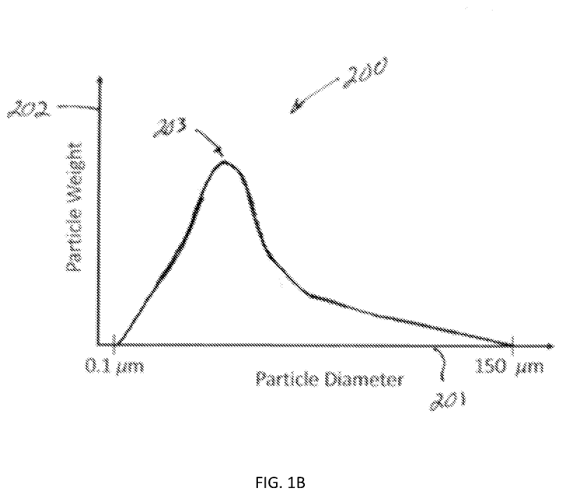

Turning to FIG. 1A there is shown a graph depicting a uni-modal distribution for a present material made from the present process and equipment, e.g., a cement, such as a Portland cement. The graph 100 has a y-axis 102, for increasing weight of the particles, a x-axis 101 for increasing diameter of the particles, and a distribution having a single band with a peak 103.

Turning to FIG. 1B there is shown a graph depicting a uni-modal distribution for a present material made from the present process and equipment, e.g., a cement, such as a Portland cement. The graph 200 has a y-axis 202, for increasing weight of the particles, a x-axis 201 for increasing diameter of the particles, and a distribution having a single band with a peak 203.

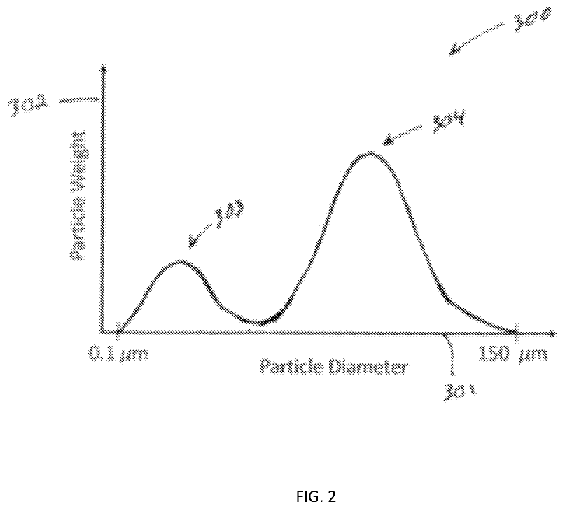

Turning to FIG. 2 there is shown a graph depicting a bi-modal distribution for a present material made from the present process and equipment, e.g., a cement, such as a Portland cement. The graph 300 has a y-axis 302, for increasing weight of the particles, a x-axis 301 for increasing diameter of the particles, and a distribution having a first band (e.g., fine band) with peak 303 and a second band (e.g., course band) with peak 304.

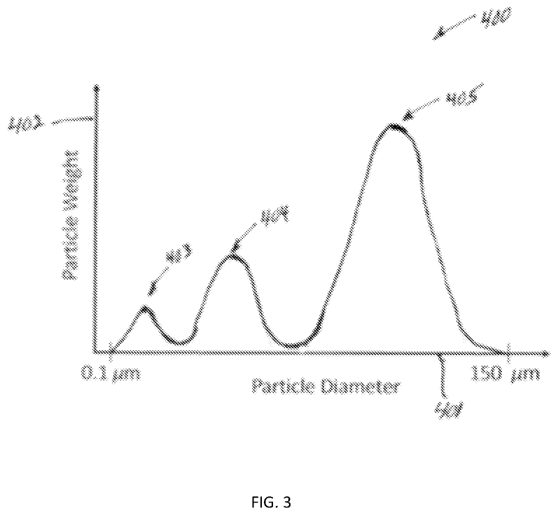

Turning to FIG. 3 there is shown a graph depicting a tri-modal distribution for a present material made from the present process and equipment, e.g., a cement, such as a Portland cement. The graph 400 has a y-axis 402, for increasing weight of the particles, a x-axis 401 for increasing diameter of the particles, and a distribution having a first band (e.g., fine band) with peak 403 and a second band (e.g., intermediate band) with peak 404 and a third band (e.g., course band) peek 405.

Generally, these starting material pellets would be made up of silica (SiO₂), e.g., in the form of clay, and calcium carbonate (CaCO₃), e.g., in the form of limestone. These starting material pellets may also contain other materials and additive. These starting pellets can contain from about 50% to about 90% calcium carbonate and from about 10% to about 59% silica, although large and smaller amounts of each may be present. Preferably these pellets have from about 60% to about 75% calcium carbonate and 25% to about 40% silica.

Generally, these starting material pellets have particle sizes from anywhere between 10 mm to about 110 mm, about 20 mm to about 90 mm, less than 120 mm, less than 100 mm and greater and smaller sizes as well. These starting material pellets can have one uniform particle size, which would be based upon a particle size distribution of having a very narrow (or tight) distribution. For example, where the D10 to D90 distributions are within 20 mm, where the D10 and D90 values are within 10 mm of each other, and where the D10 and D90 values are within 5 mm of each other, as well as tighter and wider distributions. Thus, in general, and by way of example, the starting material pellets can have any one of the following particle size distributions set forth in Table 1 (as well as combinations and variations of these values). Further different pellets types (with ‘type’ defined by size, shape or method of production and combination of these) may be combined as the starting materials. Thus, for example, a kiln could be feed with Pellets Type 2 and 11.

TABLE 1

| Pellets | D10 | D50 | D90 | D10-D90 |
|---|---|---|---|---|
| Type | mm | mm | mm | Δ mm |
| 1 | 20 | 40 | 60 | 40 |
| 2 | 25 | 40 | 55 | 30 |
| 3 | 35 | 40 | 45 | 10 |
| 4 | 30 | 60 | 90 | 60 |
| 5 | 50 | 60 | 65 | 15 |
| 6 | 55 | 60 | 70 | 15 |
| 7 | 68 | 70 | 72 | 4 |
| 8 | 60 | 70 | 80 | 20 |
| 9 | 65 | 70 | 85 | 20 |
| 10 | 75 | 80 | 85 | 10 |
| 11 | 70 | 80 | 90 | 20 |
| 12 | 75 | 80 | 85 | 10 |

FIG. 1, provides an explanation of the D50 particle distribution evaluation. The D50 is that value that represents the diameter of the particles that makes up 50% of the cumulative volume of the particles, i.e., 50% of the cumulative volume has a diameter that is at least the D50 value. The D10 is that value that represents the diameter of the particles that make up 10% of the cumulative volume of the particles, i.e., 10% of the cumulative volume has a diameter that is at least the D10 value. The D90 is that diameter of the particles that makes up 90% of the cumulative volume of the particles, i.e., 90% of the cumulative volume has a diameter that is at least the D90 value. In FIG. 1 the numbers for the particle diameter are unitless, and only illustrate increasing diameter, when moving from left to right. For embodiments of the present invention, for the starting material pellets, these diameters would range from about 10 mm to about 120 mm, as well as, greater and smaller values.

Generally, the starting material pellets can be formed, for example, by roller compaction through dry granulation, or briquetting in an oval or spherical form. Other pellet formation processes involve the use of starch based binders or moisture to hold together granules to form pellets. Other pelletizing methods may also be used to obtain the pellets have the designed particle sizes and distributions. These pellets are put into the kiln and come out a clinker an intermediary product.

One of the advantages of embodiments of the present inventions is that the use of small pellets as starting materials, such as those discussed above and shown in Table 1, combined the embodiments of the cement furnaces and kilns disclosed and taught in provisional application Ser. No. 63/055,826 filed Jul. 23, 2020 and U.S. patent application Ser. No. 17/384,672 filed Jul. 23, 2021, the entire disclosure of each of which is incorporated herein by reference, permits more energy efficient production of cement, improved heat transfer, design and the ability to leverage oxyfuel combustion. This is because the flow of gases vertically through a bed (porous media) of pellets, improves the available surface area for the hot combustion gases to transfer heat to the material. Thus, the pellets can have from about 50× to about 150×, at least about 70×, at least about 90×, at least about 100× more available surface area of the material to contact hot combustion gases.

Table 2, sets forth various illustrative embodiments of the available surface area to gas contact for embodiments of the present starting material pellets. These values as well as others may be implemented with the present starting material pellets, including those of Table 1.

TABLE 2

| | | | | | | | | |
|---|---|---|---|---|---|---|---|---|
| Diameter | 20 mm | 30 mm | 40 mm | 50 mm | 60 mm | 70 mm | 80 mm | 90 mm |
| Available Surface | 300 | 200 | 150 | 120 | 100 | 85.71 | 75 | 66.6 |
| Area (m²/m³) | | | | | | | | |

The following examples are provided to illustrate various embodiments of the present systems, apparatus, and methods. These examples are for illustrative purposes, may be prophetic, and should not be viewed as, and do not otherwise limit the scope of the present inventions.

### Example 1

Using an oxyfuel combustion process, starting material pellets having an average particle size of anywhere from about 20 mm to about 90 mm are fed into a furnace, e.g., a kiln and heated to provide a cement clinker, which is them processed into a cement, e.g., Portland cement. The cement having a uni-modal particle size distribution of from about from the 0.1 μm to about 150 μm scale where the average particle size lies anywhere between the two parameters.

### Example 1A

The process and material of Example 1, in which a cement clinker has a uni-modal particle size distribution of from about from the 0.1 μm to about 150 μm scale where the average particle size lies anywhere between the two parameters.

### Example 1B

The process and material of Example 1, in which the cement clinker has a D50 of about 70 μm, and the D10 and D90 are within 50 μm of each other.

### Example 1C

The processes of Examples 1, 1A or 1B, in which the clinker must be ground to obtain the particle sizes of the cement.

### Example 1D

The processes of Examples 1, 1A or 1B, in which grinding of the clinker is not need to obtain the particles sizes of the cement.

### Example 1E

The processes of Examples 1, 1A, 1B, 1C or 1D, in which a starting material is one, or more, of the Pellets Type from Table 1. These processes may also utilize the available surface areas of Table 2.

### Example 2

A Portland cement having a unl-modal distrlbution with a single continuous band of particle sizes from the 0.1 μm to 150 μm scale, where the average particle size lies anywhere between the two parameters.

### Example 2A

The Portland cement of Example 2, in which the peak of the uni-modal distribution is a particle diameter of about 50 μm.

### Example 2B

The Portland cement of Example 2, in which the peak of the uni-modal distribution is a particle diameter of about 25 μm.

### Example 2C

The Portland cement of Example 2, in which the peak of the uni-modal distribution is a particle diameter of about 75 μm.

### Example 2D

The Portland cement of Example 2, in which the peak of the uni-modal distribution is a particle diameter of about 100 μm.

### Example 2E

The Portland cement of Example 2, in which the peak of the uni-modal distribution is a particle diameter of about 125 μm.

### Example 2F

The Portland cements of Examples 2 to 2D, in which the delta between D10 and D50 is about 100 μm.

### Example 2G

The Portland cements of Examples 2 to 2D, in which the delta between

D10 and D50 is greater than 75 μm.

### Example 2H

The Portland cements of Examples 2 to 2D, in which the delta between D10 and D50 is greater than 50 μm.

### Example 2I

The Portland cements of Examples 2 to 2D, in which the delta between D10 and D50 is greater than 25 μm.

### Example 3

Using an oxyfuel combustion process, starting material pellets having an average particle size of from about 20 mm to about 90 mm are feed into a furnace, e.g., a kiln and heated to provide a cement clinker, which is them processed into a cement, e.g., Portland cement. The cement having a bi-modal particle size distribution of from about from the 0.1 μm to about 150 μm scale where the average particle sizes for the bands are anywhere between the two parameters.

### Example 3A

The process and material of Example 3, in which a cement clinker has a bi-modal particle size distribution of from about from the 0.1 μm to about 150 μm scale where the average particle sizes for the bands are anywhere between the two parameters.

### Example 3B

The process and material of Example 3, in which the cement clinker has a D50 of about 70 μm, and the D10 and D90 are more than 50 μm of each other.

### Example 3C

The processes of Examples 3, 3A or 3B, in which the clinker must be ground to obtain the particle sizes of the cement.

### Example 3D

The processes of Examples 3, 3A or 3B, in which grinding of the clinker is not need to obtain the particles sizes of the cement.

### Example 3E

The processes of Examples 3, 3A, 3B, 3C or 3D, in which a starting material is one, or more, of the Pellets Type from Table 1. These processes may also utilize the surface to combustion gas temperature of Table 2.

### Example 4

A Portland cement having a bi-modal distribution with two continuous bands of particle sizes from the 0.1 μm to 150 μm scale, where the average particle sizes for the bands are anywhere between the two parameters.

### Example 4A

The Portland cement of Example 4, in which the peak for the second band of the bi-modal distribution is a particle diameter of about 50 μm.

### Example 4B

The Portland cement of Example 4, in which the peak for the first band of the bi-modal distribution is a particle diameter of about 10 μm.

### Example 4C

The Portland cement of Example 4, in which the peak for the second band of the bi-modal distribution is a particle diameter of about 75 μm.

### Example 4D

The Portland cement of Example 4, in which the peak for the second band of the bi-modal distribution is a particle diameter of about 100 μm.

### Example 4E

The Portland cement of Example 4, in which the peak for the second band of the bi-modal distribution is a particle diameter of about 125 μm.

### Example 4F

The Portland cements of Examples 4 to 4E, in which the delta between D10 and D50 is about than 100 μm.

### Example 4G

The Portland cements of Examples 4 to 4E, in which the delta between D10 and D50 is more than 75 μm.

### Example 4H

The Portland cements of Examples 4 to 4E, in which the delta between

D10 and D50 is more than 50 μm.

### Example 4I

The Portland cements of Examples 4 to 4E, in which the delta between D10 and D50 is more than 25 μm.

### Example 4J

Examples 4 to 4I, where an available surface area of Table 2 is utilized.

### Example 5

The embodiments of Examples 3-3E and 4-4J having the difference between the two peaks of the bands of the bi-modal distribution being about 100 μm of each other, more than about 75 μm from each other, and being more than about 50 μm of each other.

### Example 6

Using an oxyfuel combustion process, starting material pellets having an average particle size of from about 20 mm to about 90 mm are feed into a furnace, e.g., a kiln and heated to provide a cement clinker, which is them processed into a cement, e.g., Portland cement. The cement having a tri-modal particle size distribution of from about from the 0.1 μm to about 150 μm scale where the average particle sizes for the bands are anywhere between the two parameters.

### Example 6A

The process and material of Example 6, in which a cement clinker having a tri-modal particle size distribution of from about from the 0.1 μm to about 150 μm scale where the average particle sizes for the bands are anywhere between the two parameters.

### Example 6B

The process and material of Example 3, in which the cement clinker has a D50 of about 70 μm, and the D10 and D90 are more than 50 μm of each other.

### Example 6C

The processes of Examples 6, 6A or 6B, in which the clinker must be ground to obtain the particle sizes of the cement.

### Example 6D

The processes of Examples 6, 6A or 6B, in which grinding of the clinker is not need to obtain the particles sizes of the cement.

### Example 6E

The processes of Examples 6, 6A, 6B, 6C or 6D, in which a starting material is one, or more, of the Pellets Type from Table 1. These processes may also utilize an available surface area from Table 2.

### Example 7

A Portland cement having a tri-modal distribution with three continuous band of particle sizes from the 0.1 μm to 150 μm scale, where the average particle sizes for the bands are anywhere between the two parameters.

### Example 7A

The Portland cement of Example 7, in which the peak for the second band of the tri-modal distribution is a particle diameter of about 50 μm.

### Example 7B

The Portland cement of Example 7, in which the peak for the first band of the tri-modal distribution is a particle diameter of about 10 μm.

### Example 7C

The Portland cement of Example 7, in which the peak for the third band of the tri-modal distribution is a particle diameter of about 75 μm. This embodiment may also have the peaks of Examples 7A, 7B or both.

### Example 7D

The Portland cement of Example 4, in which the peak for the third band of the tri-modal distribution is a particle diameter of about 100 μm. This embodiment may also have the peaks of Examples 7A, 7B or both.

### Example 7E

The Portland cement of Example 4, in which the peak for the third band of the tri-modal distribution is a particle diameter of about 125 μm. This embodiment may also have the peaks of Examples 7A, 7B or both.

### Example 7F

The Portland cements of Examples 7 to 4D, in which the delta between D10 and D50 is about 100 μm.

### Example 7G

The Portland cements of Examples 7 to 4D, in which the delta between D10 and D50 is more than 75 μm.

### Example 7H

The Portland cements of Examples 7 to 7D, in which the delta between D10 and D50 is more than 50 μm.

### Example 7I

The Portland cements of Examples 7 to 7D, in which the delta between D10 and D50 is more than 25 μm.

### Example 7J

Examples 7 to 7I, where an available surface area from Table 2 is utilized.

### Example 8

The embodiments of Examples 6-6E and 7 to 7J having the difference between at least two peaks of the bands of the tri-modal distribution being about 100 μm of each other, more than about 75 μm of each other, and more than about 25 μm of each other.

### Example 9

Examples of particle size distributions for Portland cement powders for bi-modal distribution include:

A widely separated ratio of the average particle sizes of particles in their respective bands or modes should be as far as practicable, since this can enhance and tailor particular cement properties. In one case if the average particle, size of the coarser mode is A1 and the average particle size of the finer mode is A2 then the ratio of A1:A2 could be from 2, to 10 even up to the range of 20 to 40.

Further a narrow range of particle sizes rather than wide in each mode is preferred, thus as narrow as is technically and economically practicably possible band is preferred. Thus, for any one band, and preferably for each band, in a bi-model distribution, the difference between the D10 and 090, for that band (i.e., considering the band as the cumulative volume) is less than 50 μm, less than 30 μm, less than 20 μm and less than 10 μm, is from about 20 μm to about 40 μm, is from about 10 μm to about 30 μm, is about 10 μm, is about 20 μm, and is about 30 μm, as well as larger and smaller values.

A preferred range of compositions, of bi-modal distribution, may be cement particle distribution that is,
(a) >50% and or 70% to 90% by weight of particles of particle size in the range 60 to 110 microns,
and
(b) about 5% and preferably 10% to 30% by weight of particles of particle size in the range 1 to 10 microns,
and
(c) about 20%, less than 10%, or less than 5%, by weight of particles of particle size outside the two ranges (a) and (b) above.

### Example 10

Examples of particle size distributions for Portland cement powders for tri-modal distribution include: weight average mean particle sizes of the three modes, coarse (A1), intermediate (A2), and fine (A3). Here the ratios of A1:A2 and A2:A3 may be similar to A1:A2 ratios in a bi-modal distribution. Although, preferably both A1:A2 and A2:A3 are not the same. The preference of a narrow range of particle sizes is &so preferred in the case of a tri-modal distribution. Thus, for any one band, and preferably for each band, in a bi-model distribution, the difference between the D10 and D90, for that band (i.e., considering the band as the cumulative volume) is less than 50 μm, less than 30 μm, less than 20 μm and less than 10 μm, is from about 20 μm to about 40 μm, is from about 10 μm to about 30 μm, is about 10 μm, is about 20 μm, and is about 30 μm, as well as larger and smaller values.

A preferred range of compositions for a trimodal distribution may include but is not limited to:
(a) about 50%, and or 70% to 90% by weight, of particles of particle size in the range 80 to 150 microns,
(b) about 5%, and or 10% to 30% by weight, of particles of particle size in the range 7 to 12 microns, and
(c) about 1%, and and or 3% to 8% by weight, of particles of particle size in the range 0.5 to 2 microns.

### Example 11

Mixtures of two or more different Portland Cements may be also used if desired.

Thus, one possible multi-modal mixture might comprise of two or more different Portland cements, one having one of the selected particle size band and the others having a different particle size bands so that together they provide the desired multi-modal distribution. For example, two different uni-model cements may be mixed.

The multi-modal distribution of particulate cement may be achieved by modifying the comminution of the raw cement particles and using appropriate classifying, separating or mixing procedures. This may include but is not limited to, the cement being classified by sieving or any other convenient means, into portions of selected size range distributions, and then these fractions are mixed in selected proportions with each other, with some of the original unclassified material, and both so as to achieve the multi-modal distribution in the final mixture.

It is believed that prior to the present inventions there has never been a low carbon, carbon neutral process and both that is produces cement, e.g., ASTM C150 standard cement, that has the present particle size distribution features set forth in these Examples and this Specification,

### Example 12

Examples of pellet size distributions for clinker forming pellets include uni-modal and multi-modal pellet size distribution profiles in the range of about 20 mm to about 90 mm. This can be done by producing and using in the kiln, pellets at two different sizes. The distribution can also be narrow (e.g., 20-30 mm) or wide (e.g., 20-80 mm). A narrow particle size distribution leads to more uniform behavior and clinker production while a varied distribution leads to different rates of clinker formation for different size pellets, Smaller particles will heat up faster in the preheating zone and cool faster in the cooling zone than the larger particles. This occurs because the convective heat transfer coefficient decreases with diameter at power of 0.5. While maximum surface temperature will not differentiate substantially between the different particle sizes. The core temperatures, on the other hand, and chemical conversion may be considerably different and incomplete in larger pellet sizes.

### Example 13

The production of pellets of starting material are used in the processes and equipment of U.S. patent application Ser. No. 63/055,826 and U.S. patent application Ser. No. 17/384,672, the entire disclosure of each of which is incorporated herein by reference. Among other things, the embodiment of this Example overcomes the limitations of the use of oxy-combustion in the manufacture of cement. To date prior embodiments and applications of shaft kilns typically focused on the use of coal or coke and mixing that within the raw material to form pellets. This approach can often lead to multiple and long standing problems. First, the release of volatiles in coal can alter the temperature profile of the kiln and create hot exit gas temperatures and poor efficiencies. Second, incomplete combustion and to formation of soot making any CO₂ capture process extremely difficult. In an embodiment of the present processes, the use of natural gas in air or oxygen, avoid the use of coal or coke—improving energy efficiency of the cement manufacturing process by offering near complete combustion and there by producing little to no soot.

### Example 14

Using an oxyfuel combustion process, starting material pellets having an average particle size of anywhere from about 20 mm to about 90 mm are fed into a furnace, e.g., a kiln and heated to provide a cement clinker, which is them processed into a cement, e.g., Portland cement. The cement having a uni-modal particle size distribution of from about from the 0.1 μm to about 150 μm scale where the average particle size lies anywhere between the two parameters. The starting material pellets may be selected from one or more of the Pellet Types of Table 1. The cement may have a narrow or tight band width for the uni-modal band. Thus, the delta between D10 and D90 for the particles may be less than 50 μm, less than 25 μm, less than 10 μm, and less than 5 μm. The cement may have a wide or broad band width for the uni-modal band. Thus, the delta between D10 and D90 for the particles may be greater than 75 μm, greater than 90 μm, greater than 100 μm, and greater than 125 μm. The cements may further have the diameters and active surface areas of Table 2.

### Example 15

The combination of any one or more of the features, processes, and materials of the embodiments of the forging Examples 1 to 14.

It is noted that there is no requirement to provide or address the theory underlying the novel and groundbreaking performance or other beneficial features and properties that are the subject of, or associated with, embodiments of the present inventions. Nevertheless, various theories are provided in this specification to further advance the art in this important area, and in particular in the important area of cement and materials manufacture, calcining, pyrolysis, cost controls and minimizing green house gasses. These theories put forth in this specification, and unless expressly stated otherwise, in no way limit, restrict or narrow the scope of protection to be afforded the claimed inventions. These theories many not be required or practiced to utilize the present inventions. It is further understood that the present inventions may lead to new, and heretofore unknown theories to explain the operation, function and features of embodiments of the methods, articles, materials, devices and system of the present inventions; and such later developed theories shall not limit the scope of protection afforded the present inventions.

The various embodiments of kilns, processes, methods, assemblies, activities and operations set forth in this specification may be used in the above identified fields and in various other fields. Additionally, these embodiments, for example, may be used with: existing furnaces, systems, operations and activities as well as other existing equipment; future furnaces, systems operations and activities; and such items that may be modified, in-part, based on the teachings of this specification. Further, the various embodiments set forth in this specification may be used with each other in different and various combinations. Thus, for example, the configurations provided in the various embodiments of this specification may be used with each other. For example, the components of an embodiment having A, A′ and B and the components of an embodiment having A″, C and D can be used with each other in various combination, e.g., A, C, D, and A. A″ C and D, etc., in accordance with the teaching of this Specification. The scope of protection afforded the present inventions should not be limited to a particular embodiment, configuration or arrangement that is set forth in a particular embodiment, example, or in an embodiment in a particular Figure.

The invention may be embodied in other forms than those specifically disclosed herein without departing from its spirit or essential characteristics. The described embodiments are to be considered in all respects only as illustrative and not restrictive.

1. A method of making a cement having a multi-modal particle size distribution, comprising particles having a diameter, from 0.1 μm to about 150 μm, and producing low carbon emissions, whereby at least 98% of any carbon used in the method is captured.

2. The method of claim 1, wherein at least 99.5% of the carbon is captured.

3. The method of claim 1, wherein the cement is a Portland cement.

4. The method of claim 1, wherein the cement comprises a bi-modal distribution, wherein the distribution has at least two bands; comprising a first band having a first band peak, and a second band having a second band peak.

5. The method of claim 4, wherein a difference between the first band peak and the second band peak is at least 50 μm.

6. (canceled)

7. (canceled)

8. (canceled)

9. The method of claim 4, wherein the ratio of the first band peak to the second band peak is from 2 to about 10.

10. (canceled)

11. (canceled)

12. The method of claim 4, wherein the cement particle size distribution comprises a third band.

13. The method of claim 12, wherein the third band is an intermediate band.

14. (canceled)

15. (canceled)

16. (canceled)

17. The method of claim 4, wherein at least one of the bands defines a D10 value and a D90 value and the difference between the D10 and D90 values is less than 20 μm.

18. (canceled)

19. A low carbon cement having a particle size distribution comprising a first band and a second band, wherein the first band comprises a first band peak, and the second band comprises a second band peak, wherein the ratio of the first band peak to the second band peak is from about 2 to about 10.

20. The cement of claim 19, wherein the particle size distribution consists essentially of a bi-modal distribution; thereby defining a bi-modal distribution.

21. The cement of claim 19, wherein the particle size distribution comprises a third band.

22. A carbon neutral cement having a particle size distribution comprising a first band and a second band, wherein the first band comprises a first band peak, and the second band comprises a second band peak, wherein the ratio of the first band peak to the second band peak is from about 2 to about 10.

23. The cement of claim 22, wherein the particle size distribution consists essentially of a bi-modal distribution; thereby defining a bi-modal distribution.

24. The cement of claim 22, wherein the particle size distribution comprises a third band.

25. A plurality of starting material pellets configured for use in the manufacture of a cement:
a. the pellets comprising silica and calcium carbonate;
b. the pellets having particle sizes within the range of 20 mm to 80 mm;
c. the pellets having at least one distribution band having a D10 value and a D90 value, and thereby defining a first band width.

26. The starting material of claim 25, comprising a second distribution band having a D10 value and a D90 value, and thereby defining a second band width.

27. (canceled)

28. The starting material of claim 25, wherein the first band width, the second band width or both is less than 10 mm.

29. (canceled)

30. The starting material of claim 26, wherein a difference between a peak of the first band and a peak of the second band is at least 50 mm.

31. (canceled)

32. (canceled)

33. (canceled)

34. The starting material of claim 26, comprising a third distribution band.

35. (canceled)

36. A method for producing cement having a particle size distribution from about 0.1 μm to about 150 μm, the method including the steps of:
a. feeding a starting material pellets comprising limestone and a source of silica into a furnace;
b. feeding oxygen at high purity into the furnace;
c. feeding a fuel comprising, carbon, hydrogen, or both into the furnace;
d. combustion oxygen with the fuel in the furnace, where the combustion reaction provides high flame temperatures above 2000 C;
e. thereby producing a cement clinker.

37. The method of claim 36, comprising processing the cement clinker into a cement.

38. The method of claim 36, wherein the cement is a Portland cement.

39. The method of claim 36, wherein staring material pellets have a particle size of from about 10 mm to about 110 mm.

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)
